(19) United States
(12) Patent Application Publication
(10) Pub. No.: US 2012/0280002 A1
(43) Pub. Date: Nov. 8, 2012

(54) NASAL IRRIGATION DEVICE

(75) Inventor: Ko-Wen HUANG, New Taipei City (TW)

(73) Assignee: SHIH-KANG MEDICAL INSTRUMENTS CO., LTD., New Taipei City (TW)

(21) Appl. No.: 13/101,092

(22) Filed: May 4, 2011

(51) Int. Cl. B67D 7/02

(52) U.S. Cl. 222/562

(57) ABSTRACT

The nasal irrigation device has a container, a cover, a spout and a cap. The container has a neck and a tail. The cover is mounted detachably on the neck of the container and has a pressure adjusting hole. The spout is mounted detachably on the tail of the container and has a connecting tube connected to a guiding tube. The guiding tube has a nozzle. The cap is mounted detachably on the nozzle of the guiding tube of the spout. Therefore, the nasal irrigation device can be cleaned conveniently because all the components can be easily disassembled. Besides, the cap can plug the nozzle to stop a saline solution inside the container from spouting out and also can keep the nozzle clean.

### BACKGROUND OF THE INVENTION

1. Field of the Invention

The present invention relates to a nasal irrigation device, and more particularly to a nasal irrigation device that can be cleaned conveniently.

2. Description of the Prior Arts

Nasal irrigation devices are used to wash nasal cavities with a saline solution for alleviating allergies. With reference to FIGS. 5 and 6, a conventional nasal irrigation device disclosed in Taiwan Patent No. 376747 comprises a container 5, a cover 51, a nozzle 6 and a sleeve 7. The container 5 is filled with a saline solution and has a top opening, a bottom end and a guiding tube 53. The guiding tube 53 protrudes forward and upward from the bottom end of the container 5.

The cover 51 covers the top opening of the container 5 and has a gas hole 52.

The nozzle 6 is mounted securely around the guiding tube 53 of the container 5 and has a connecting tube 61, a flange 62, a plug 63, two ribs 64 and two holes 65. The connecting tube 61 has an outer surface, an inner surface, a front end and an interior. The flange 62 protrudes radially from the outer surface of the connecting tube 61 and is formed around the front end of the connecting tube 61. The plug 63 is positioned at a center of the front end of the connecting tube 61 and has a rear end. The ribs 64 are respectively connected between the rear end of the plug 63 and the inner surface of the connecting tube 61. The communicating holes 65 are respectively defined between the ribs 64 and communicate with the interior of the connecting tube 61.

The sleeve 7 is mounted on the nozzle 6 and has a head, a spout passage 71, a tubular connector 72, two rings 73 and an annular recess 74. The spout passage 71 is formed through the head. The tubular connector 72 is connected to the head, is mounted movably around the connecting tube 61 of the nozzle 6 and has an interior, an inner surface and a middle section. The interior of the tubular connector 72 communicates with the spout passage 71. The rings 73 are respectively formed around and protrude from the inner surface and the middle section of the tubular connector 72. The annular recess 74 is defined between the rings 73 to allow the flange 62 of the nozzle 6 to be clamped.

With reference to FIG. 7, the sleeve 7 is pressed to the nozzle 6 to make the plug 63 of the nozzle 6 plug the spout passage 71 of the sleeve 7 to stop the saline solution inside the container 5 from spouting out. With reference to FIG. 6, the sleeve 7 is pulled from the nozzle 6 to make the plug 63 of the nozzle 6 depart from the spout passage 71 of the sleeve 7 and the flange 62 of the nozzle 6 be clamped between the rings 73 of the sleeve 7. Thus, the saline solution inside the container 5 will spout out from the sleeve 7 to wash nasal cavities. In addition, the flange 62 of the nozzle 6 clamped between the rings 73 of the sleeve 7 prevents the sleeve 7 from drawing back to the nozzle 6.

However, the guiding tube 53 of the container 5 is bent so is difficult to clean. The container 5, the nozzle 6 and the sleeve 7 cannot be easily disassembled for cleaning these components separately. Consequently, bacteria will collect on these components and infect users.

Besides, the sleeve 7 is inserted into and directly contacts a nasal passage during nasal irrigation so the sleeve 7 must be cleaned after each use. The sleeve 7 is always exposed so the sleeve 7 must be cleaned before each use as well even though the sleeve 7 has been cleaned after the previous use. Thus, the sleeve 7 must be cleaned frequently and is inconvenient to use.

Moreover, the plug 63 of the nozzle 6 and the spout passage 71 of the sleeve 7 have to be made with great precision, otherwise the saline solution will leak out when the sleeve 7 is pressed to the nozzle 6. The great precision requirement significantly raises costs for production and lowers productivity.

To overcome the shortcomings, the present invention provides a nasal irrigation device to mitigate or obviate the aforementioned problems.

### SUMMARY OF THE INVENTION

The main object of the present invention is to provide a nasal irrigation device that can be conveniently cleaned.

To achieve the foregoing objective, the nasal irrigation device in accordance with the present invention comprises a container, a cover, a spout and a cap. The container has an X-axis direction, a top end, a bottom end, an interior, a neck and a tail. The neck protrudes from the top end of the container and has a top opening The top opening communicates with the interior of the container and is positioned in the X-axis direction. The tail protrudes from the bottom end of the container and has a bottom opening and an outside thread. The bottom opening communicates with the interior of the container and is positioned in the X-axis direction. The cover is mounted detachably on the neck of the container and has a pressure adjusting hole. The spout is mounted detachably on the tail of the container and has a connecting tube and a guiding tube. The connecting tube has an outer surface and an inside thread. The inside thread is screwed onto the outside thread of the tail of the container. The guiding tube protrudes upward and aslant from the outer surface of the connecting tube, communicates with the connecting tube and has a tip end and a nozzle. The nozzle is formed on the tip end. The cap is mounted detachably on the nozzle of the guiding tube of the spout. Therefore, the nasal irrigation device can be cleaned conveniently because the container is not bent and all the components are easily disassembled. Besides, the cap can plug the nozzle to stop a saline solution inside the container from spouting out and also can keep the nozzle clean.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a nasal irrigation device in accordance with the present invention;

FIG. 2 is an exploded perspective view of the nasal irrigation device in FIG. 1;

FIG. 3 is a side view in partial section of the nasal irrigation device in FIG. 1;

FIG. 4 is a bottom view in partial section of the nasal irrigation device in FIG. 1;

FIG. 5 is a perspective view of a conventional nasal irrigation device in accordance with the prior art;

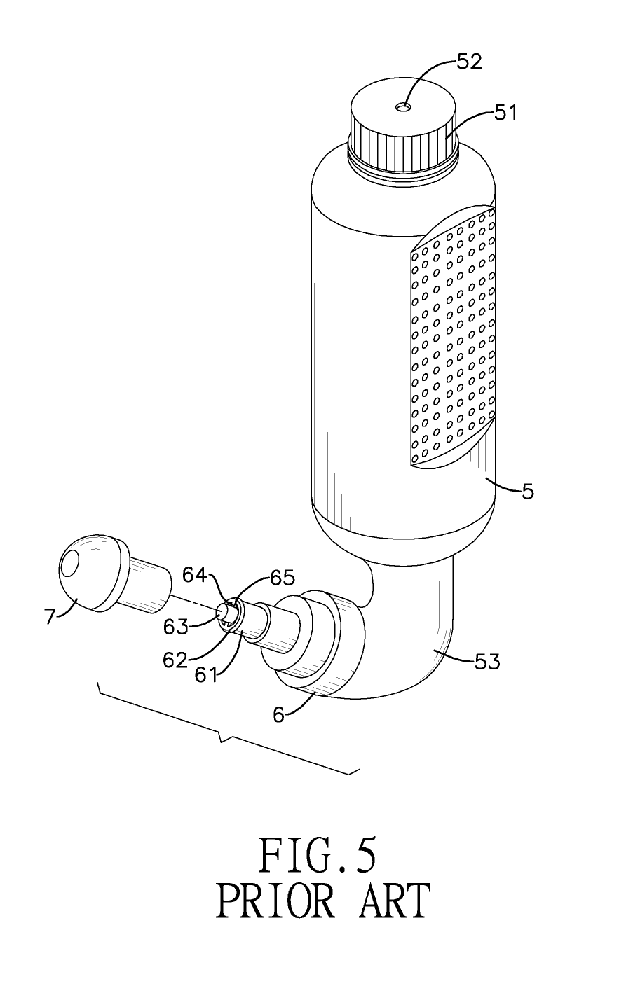

FIG. 6 is a side view in partial section of the conventional nasal irrigation device in FIG. 5, showing a sleeve being pulled from a nozzle; and

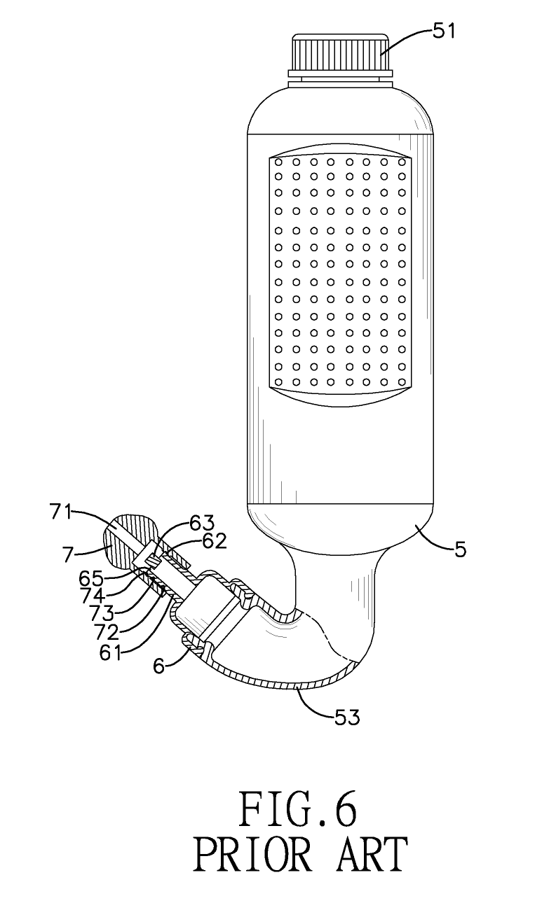

FIG. 7 is a side view in partial section of the conventional nasal irrigation device in FIG. 5, showing the sleeve being pressed to the nozzle.

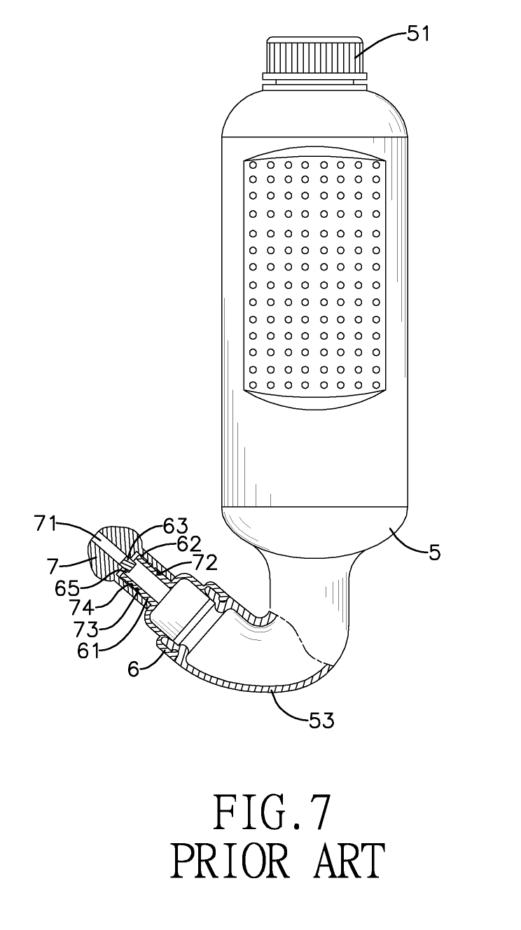

### DETAILED DESCRIPTION OF THE PREFERRED EMBODIMENTS

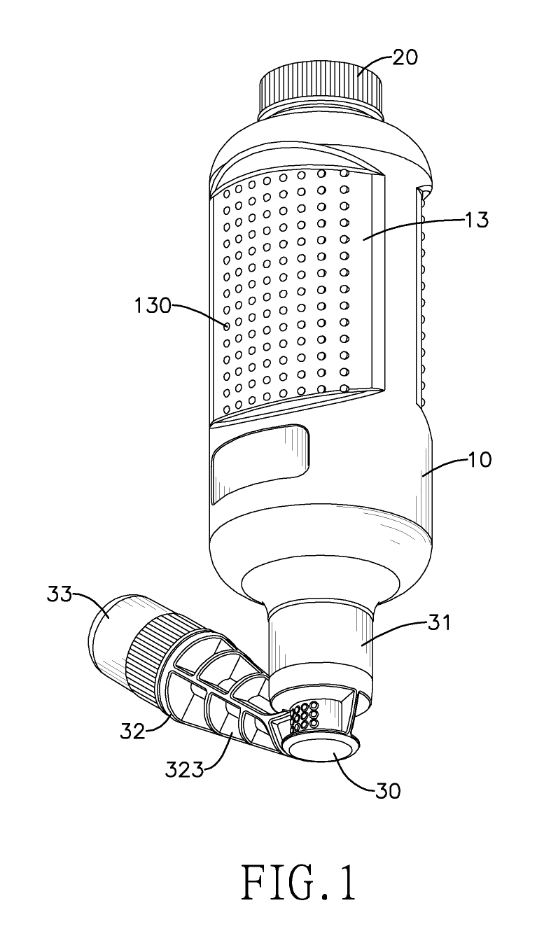

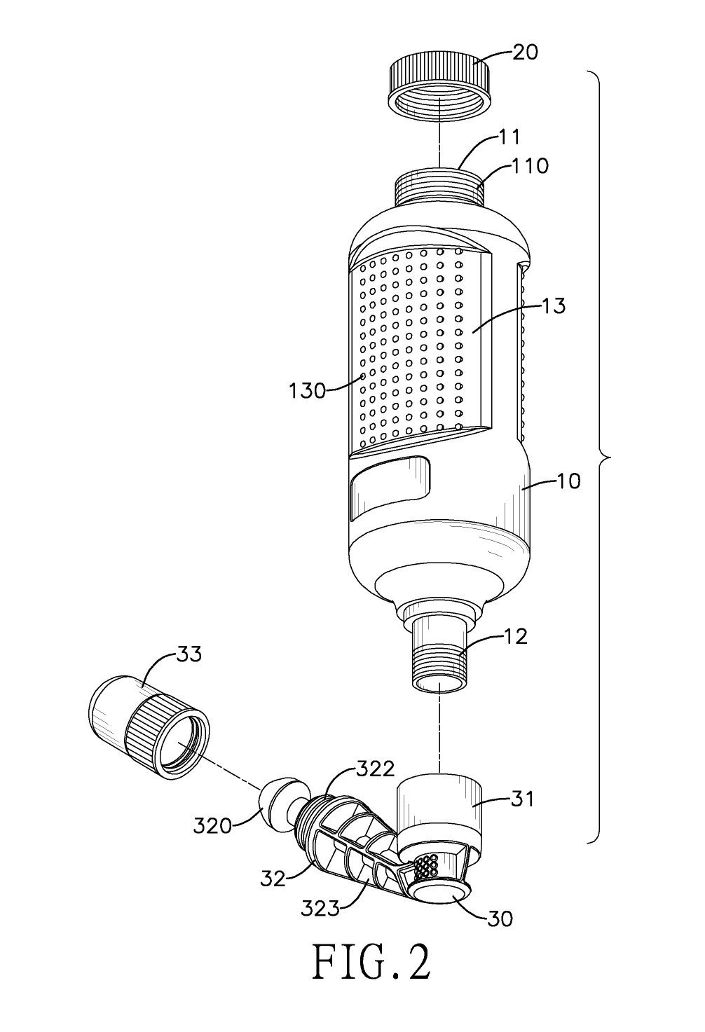

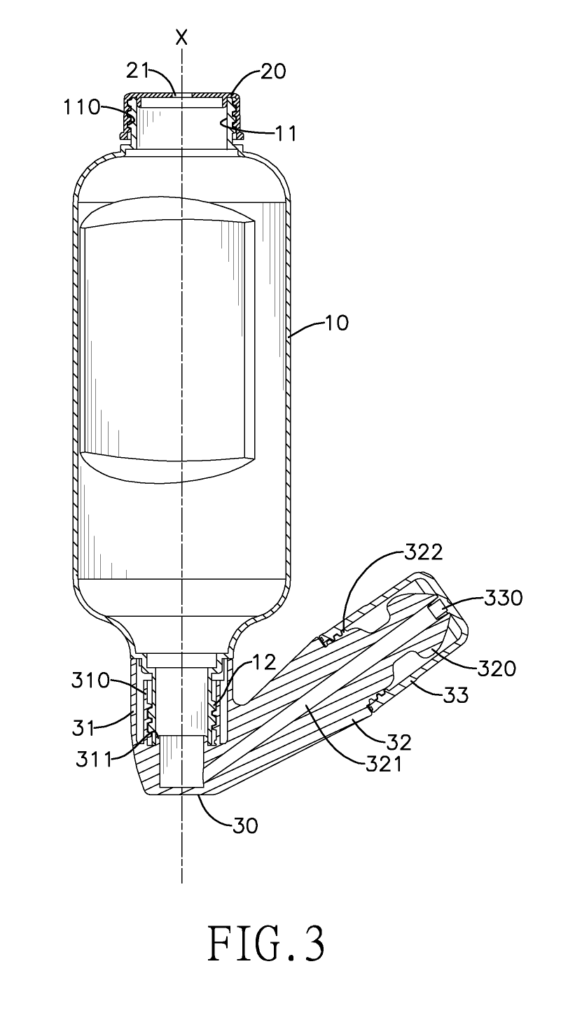

With reference to FIGS. 1 to 3, a nasal irrigation device in accordance with the present invention comprises a container 10, a cover 20, a spout 30 and a cap 33.

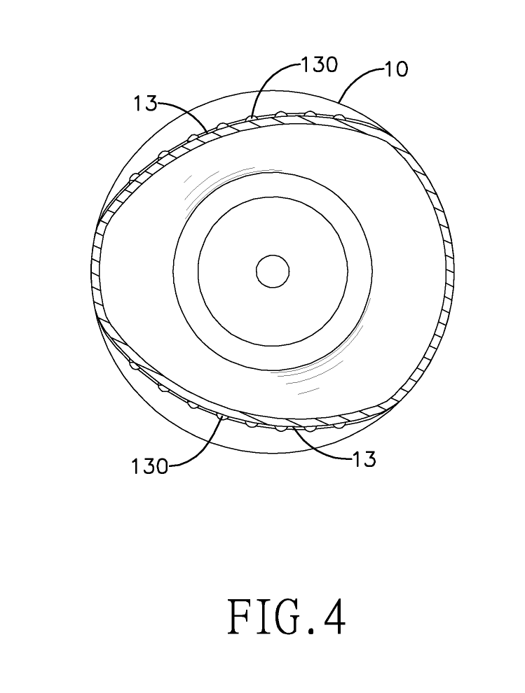

The container 10 is a hollow cylinder and has an X-axis direction, a top end, a bottom end, an interior, an outer surface, an outer diameter, a neck 11, a tail 12, two recesses 13 and multiple skidproof bosses 130. The neck 11 is hollow, protrudes from the top end of the container 10 and has an outer diameter, a top opening and an outside thread. The outer diameter of the neck 11 is less than the outer diameter of the container 10. The top opening communicates with the interior of the container 10 and is positioned in the X-axis direction. The tail 12 is hollow, protrudes from the bottom end of the container 10 and has an outer diameter, a bottom opening and an outside thread. The outer diameter of the tail 12 is less than the outer diameter of the container 10. The bottom opening communicates with the interior of the container 10 and is positioned in the X-axis direction. The top opening and the bottom opening may be positioned on a same straight line in the X-axis direction as shown in the figures or may be positioned respectively on different straight lines in the X-axis direction. With further reference to FIG. 4, the recesses 13 are respectively formed in the outer surface of the container 10 for the container 10 to be conveniently held. The skidproof bosses 130 protrude from recess surfaces of the recesses 13.

The cover 20 is mounted detachably on the neck 11 of the container 10 and has an open bottom, a closed top, an inside thread, and a pressure adjusting hole 21. The inside thread of the cover 20 is screwed onto the outside thread of the neck 11 of the container 10. The pressure adjusting hole 21 is formed through the closed top of the cover 20.

The spout 30 is mounted detachably on the tail 12 of the container 10 and has a connecting tube 31 and a guiding tube 32. The connecting tube 31 has an open top, a closed bottom, an outer surface, a threaded tube 310 and an abutting ring 311. The threaded tube 310 is formed inside the connecting tube 31 and has an inside thread screwed onto the outside thread of the tail 12 of the container 10. The abutting ring 311 is formed inside the threaded tube 310 and plugs the bottom opening of the tail 12 of the container 10. Thus, tightness between the spout 30 and the container 10 is stable. The guiding tube 32 protrudes upward and aslant from the outer surface of the connecting tube 31, communicates with the connecting tube 31 and has a tip end, an outer surface, a nozzle 320, a spout passage 321, an outer thread 322 and multiple hollow portions 323. The nozzle 320 is formed on the tip end. The spout passage 321 is defined inside the guiding tube 32 and communicates with the connecting tube 31. The outer thread 322 is formed around the outer surface of the guiding tube 32 near the nozzle 320. The hollow portions 323 are formed in the outer surface of the guiding tube 32 to reduce material costs and improve aesthetic appearance.

The cap 33 is mounted detachably on the nozzle 320 of the guiding tube 32 of the spout 30 and has an open bottom, a closed top, an inner thread and a plug 330. The inner thread of the cap 33 is screwed onto the outer thread 322 of the guiding tube 32 of the spout 30 so tightness between the cap 33 and the spout 30 is stable. The plug 330 protrudes from a lower surface of the closed top of the cap 33 and plugs the spout passage 321 of the guiding tube 32 of the spout 30 to prevent leakage.

In use, the container 10 is filled with a saline solution and is held in a user's hand. When the user's finger (e.g. forefinger) presses on the pressure adjusting hole 21 of the cover 20, the saline solution cannot spout out even though the cap 33 is detached from the spout 30 because the pressure inside the container 10 is lower than the pressure outside the container 10. When the user's finger is removed from the pressure adjusting hole 21 of the cover 20 and the cap 33 is detached from the spout 30, the saline solution can spout out through the connecting tube 31 and guiding tube 32 of the spout 30 for nasal irrigation because the pressure inside the container 10 is changed.

Therefore, the nasal irrigation device in accordance with the present invention is conveniently operated and all the components can be tightly connected to prevent leakage of the saline solution and also can be easily disassembled, cleaned and sanitized. Besides, the container 10 is not bent so is convenient to clean. Further, the cap 33 mounted on the nozzle 320 of the spout 30 can keep the nozzle 320 clean so the nozzle 320 does not have to be cleaned frequently. Additionally, all the components are connected to each other by threaded parts and do not need to be made with great precision, so this increases production efficiency while reducing costs.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A nasal irrigation device comprising:
a container having
an X-axis direction;
a top end;
a bottom end;
an interior;
a neck protruding from the top end of the container and having
a top opening communicating with the interior of the container and positioned in the X-axis direction; and
a tail protruding from the bottom end of the container and having
a bottom opening communicating with the interior of the container and positioned in the X-axis direction; and
an outside thread;
a cover mounted detachably on the neck of the container and having a pressure adjusting hole;
a spout mounted detachably on the tail of the container and having
a connecting tube having
an outer surface; and
an inside thread screwed onto the outside thread of the tail of the container; and
a guiding tube protruding upward and aslant from the outer surface of the connecting tube, communicating with the connecting tube and having a tip end and a nozzle formed on the tip end; and
a cap mounted detachably on the nozzle of the guiding tube of the spout.

2. The nasal irrigation device as claimed in claim 1, wherein
the connecting tube of the spout has an open top, a closed bottom and a threaded tube formed inside the connecting tube and having the inside thread;
the guiding tube of the spout has
an outer surface;
a spout passage defined inside the guiding tube and communicating with the connecting tube; and
an outer thread formed around the outer surface of the guiding tube near the nozzle; and
the cap has an inner thread screwed onto the outer thread of the guiding tube of the spout.

3. The nasal irrigation device as claimed in claim 2, wherein the connecting tube of the spout has an abutting ring formed inside the threaded tube and plugging the bottom opening of the tail of the container.

4. The nasal irrigation device as claimed in claim 3, wherein the cap has a closed top and a plug protruding from a lower surface of the closed top of the cap and plugging the spout passage of the guiding tube of the spout.

5. The nasal irrigation device as claimed in claim 4, wherein the guiding tube of the spout has multiple hollow portions formed in the outer surface of the guiding tube.

6. The nasal irrigation device as claimed in claim 1, wherein
the container is a hollow cylinder and has an outer diameter;
the neck of the container is hollow and has
an outer diameter being less than the outer diameter of the container; and
an outside thread; and
the cover has an inside thread screwed onto the outside thread of the neck of the container.

7. The nasal irrigation device as claimed in claim 2, wherein
the container is a hollow cylinder and has an outer diameter;
the neck of the container is hollow and has
an outer diameter being less than the outer diameter of the container; and
an outside thread; and
the cover has an inside thread screwed onto the outside thread of the neck of the container.

8. The nasal irrigation device as claimed in claim 3, wherein
the container is a hollow cylinder and has an outer diameter;
the neck of the container is hollow and has
an outer diameter being less than the outer diameter of the container; and
an outside thread; and
the cover has an inside thread screwed onto the outside thread of the neck of the container.

9. The nasal irrigation device as claimed in claim 4, wherein
the container is a hollow cylinder and has an outer diameter;
the neck of the container is hollow and has
an outer diameter being less than the outer diameter of the container; and
an outside thread; and
the cover has an inside thread screwed onto the outside thread of the neck of the container.

10. The nasal irrigation device as claimed in claim 5, wherein
the container is a hollow cylinder and has an outer diameter;
the neck of the container is hollow and has
an outer diameter being less than the outer diameter of the container; and
an outside thread; and
the cover has an inside thread screwed onto the outside thread of the neck of the container.

11. The nasal irrigation device as claimed in claim 6, wherein the tail of the container is hollow and has an outer diameter being less than the outer diameter of the container.

12. The nasal irrigation device as claimed in claim 7, wherein the tail of the container is hollow and has an outer diameter being less than the outer diameter of the container.

13. The nasal irrigation device as claimed in claim 8, wherein the tail of the container is hollow and has an outer diameter being less than the outer diameter of the container.

14. The nasal irrigation device as claimed in claim 9, wherein the tail of the container is hollow and has an outer diameter being less than the outer diameter of the container.

15. The nasal irrigation device as claimed in claim 10, wherein the tail of the container is hollow and has an outer diameter being less than the outer diameter of the container.

16. The nasal irrigation device as claimed in claim 11, wherein the container has
an outer surface;
two recesses respectively formed in the outer surface of the container and having recess surfaces; and
multiple skidproof bosses protruding from the recess surfaces of the recesses.

17. The nasal irrigation device as claimed in claim 12, wherein the container has
an outer surface;
two recesses respectively formed in the outer surface of the container and having recess surfaces; and
multiple skidproof bosses protruding from the recess surfaces of the recesses.

18. The nasal irrigation device as claimed in claim 13, wherein the container has
an outer surface;
two recesses respectively formed in the outer surface of the container and having recess surfaces; and
multiple skidproof bosses protruding from the recess surfaces of the recesses.

19. The nasal irrigation device as claimed in claim 14, wherein the container has
an outer surface;
two recesses respectively formed in the outer surface of the container and having recess surfaces; and
multiple skidproof bosses protruding from the recess surfaces of the recesses.

20. The nasal irrigation device as claimed in claim 15, wherein the container has
an outer surface;
two recesses respectively formed in the outer surface of the container and having recess surfaces; and
multiple skidproof bosses protruding from the recess surfaces of the recesses.
